(19) United States
(12) Patent Application Publication
(10) Pub. No.: US 2024/0086826 A1
(43) Pub. Date: Mar. 14, 2024

(54) INFORMATION PROCESSING APPARATUS, INFORMATION PROCESSING METHOD, AND NON-TRANSITORY COMPUTER READABLE MEDIUM

(71) Applicant: TOYOTA JIDOSHA KABUSHIKI KAISHA, Toyota-shi (JP)

(72) Inventor: Yuta SHISHIME, Tokyo-to (JP)

(73) Assignee: TOYOTA JIDOSHA KABUSHIKI KAISHA, Toyota-shi (JP)

(21) Appl. No.: 18/462,405

(22) Filed: Sep. 7, 2023

(30) Foreign Application Priority Data
Sep. 14, 2022 (JP) 2022-146567

(51) Int. Cl. G06Q 10/0833

(52) U.S. Cl. CPC G06Q 10/0833

(57) ABSTRACT

An information processing apparatus includes a memory configured to store information on a first delivery area including a predetermined location to which a package is to be delivered and information on a vehicle designated by a consignee as a delivery destination of the package, a communication interface configured to receive positional information for the vehicle, and a controller configured to formulate a delivery plan, in which the vehicle is assigned to a delivery destination in the first delivery area, based on the information on the first delivery area including the predetermined location and the information on the vehicle and to exclude the vehicle from the delivery destination in the delivery plan when the vehicle moves from the predetermined location before completion of delivery to the vehicle, or when the vehicle is not located at the predetermined location at a target time before completion of delivery to the vehicle.

### CROSS-REFERENCE TO RELATED APPLICATION

This application claims priority to Japanese Patent Application No. 2022-146567 filed on Sep. 14, 2022, the entire contents of which are incorporated herein by reference.

### TECHNICAL FIELD

The present disclosure relates to an information processing apparatus, an information processing method, and a non-transitory computer readable medium.

### BACKGROUND

Technology for package delivery in which the trunk of a vehicle can be designated as the delivery destination is known. For example, Patent Literature (PTL) 1 discloses requesting payment of a usage fee based on the time a package is left in a shared vehicle that can be used as a delivery destination for packages and reducing the usage fee in a case in which the shared vehicle moves while the package is loaded thereon.

### CITATION LIST

### Patent Literature

PTL 1: JP 2019-145004 A

### SUMMARY

Technology for package delivery in which the trunk of a vehicle can be designated as the delivery destination has room for improvement.

It would be helpful to improve technology for package delivery in which the trunk of a vehicle can be designated as the delivery destination.

An information processing apparatus according to an embodiment of the present disclosure is an information processing apparatus for managing delivery of packages, the information processing apparatus including:
a memory configured to store information on a first delivery area including a predetermined location to which a package is to be delivered and information on a vehicle designated by a consignee as a delivery destination of the package;
a communication interface configured to receive positional information for the vehicle; and
a controller configured to formulate a delivery plan, in which the vehicle is assigned to a delivery destination in the first delivery area, based on the information on the first delivery area including the predetermined location and the information on the vehicle and to exclude the vehicle from the delivery destination in the delivery plan in a case in which the vehicle moves from the predetermined location before completion of delivery to the vehicle, or in a case in which the vehicle is not located at the predetermined location at a target time before completion of delivery to the vehicle.

An information processing method according to an embodiment of the present disclosure is an information processing method to be executed by an information processing apparatus for managing delivery of packages, the information processing method including:
storing information on a first delivery area including a predetermined location to which a package is to be delivered and information on a vehicle designated by a consignee as a delivery destination of the package;
receiving positional information for the vehicle;
formulating a delivery plan, in which the vehicle is assigned to a delivery destination in the first delivery area, based on the information on the first delivery area including the predetermined location and the information on the vehicle; and
excluding the vehicle from the delivery destination in the delivery plan in a case in which the vehicle moves from the predetermined location before completion of delivery to the vehicle, or in a case in which the vehicle is not located at the predetermined location at a target time before completion of delivery to the vehicle.

A non-transitory computer readable medium according to an embodiment of the present disclosure stores a program configured to cause an information processing apparatus for managing delivery of packages to execute operations, the operations including:
storing information on a first delivery area including a predetermined location to which a package is to be delivered and information on a vehicle designated by a consignee as a delivery destination of the package;
receiving positional information for the vehicle;
formulating a delivery plan, in which the vehicle is assigned to a delivery destination in the first delivery area, based on the information on the first delivery area including the predetermined location and the information on the vehicle; and
excluding the vehicle from the delivery destination in the delivery plan in a case in which the vehicle moves from the predetermined location before completion of delivery to the vehicle, or in a case in which the vehicle is not located at the predetermined location at a target time before completion of delivery to the vehicle.

According to an embodiment of the present disclosure, technology for package delivery in which the trunk of a vehicle can be designated as the delivery destination is improved.

### BRIEF DESCRIPTION OF THE DRAWINGS

In the accompanying drawings:

FIG. 1 is a diagram schematically illustrating operations of an information processing system according to an embodiment of the present disclosure;

FIG. 2 is a diagram illustrating the movement of vehicles between delivery areas of a delivery service provider;

FIG. 3 is a block diagram illustrating a schematic configuration of the information processing system; and

FIG. 4 is a flowchart illustrating operations of an information processing apparatus.

### DETAILED DESCRIPTION

Hereinafter, an embodiment of the present disclosure will be described.

(Overview of Information Processing System)

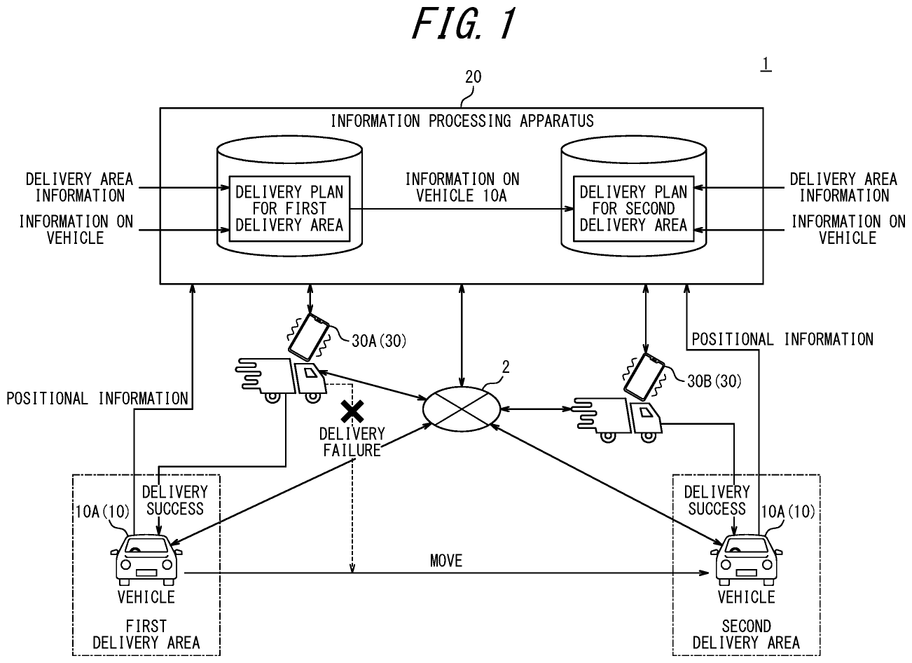

With reference to FIG. 1, an information processing system 1 according to the embodiment of the present disclosure will be described. The information processing system 1 includes a vehicle 10, an information processing apparatus 20, and a mobile terminal 30. The vehicle 10, the information processing apparatus 20, and the mobile terminal 30 are communicably connected to a network 2 including, for example, the Internet, a mobile communication network, and the like.

The vehicle 10 is an automobile, for example, but is not limited to this, and may be any appropriate vehicle. The automobile is a gasoline vehicle, a battery electric vehicle (BEV), a hybrid electric vehicle (HEV), a plug-in hybrid electric vehicle (PHEV), a fuel cell electric vehicle (FCEV), or the like, but is not limited to these.

The vehicle 10 is a vehicle designated by a consignee as the delivery destination of a package and has a trunk to which a delivery person from a delivery service provider delivers the package. The trunk of the vehicle 10 is locked when parked. The vehicle 10 may be unlocked/locked by an electronic key. For example, if an electronic key (such as a one-time key) is transmitted in advance from the information processing apparatus 20 to the mobile terminal 30, the delivery person can hold the mobile terminal 30 over the vehicle 10 and lock/unlock the vehicle using near field communication technology. For example, in response to an operation by the delivery person, the mobile terminal 30 may transmit an unlock/lock request to the information processing apparatus 20, and the information processing apparatus 20 may unlock/lock the vehicle 10 by transmitting an unlock/lock command to the vehicle.

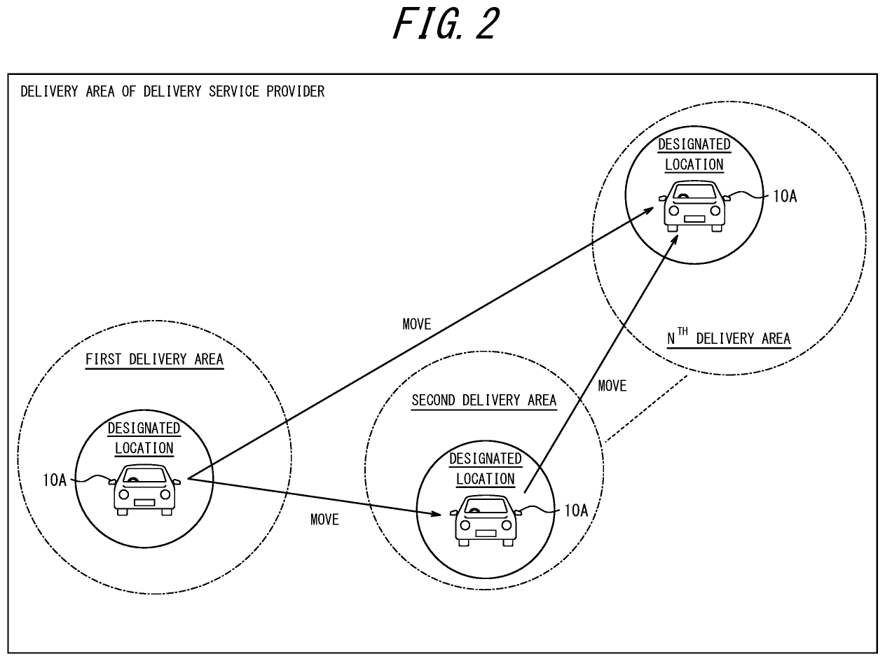

The positional information for the vehicle 10 is transmitted to the information processing apparatus 20 via the network 2. The vehicle 10 may, for example, move from within a first delivery area registered in the delivery plan for the first delivery area to within a second delivery area, . . . , n^{th} delivery area, which are outside the first delivery area, due to the consignee's circumstances, as illustrated in FIG. 2. The vehicle 10 transmits its positional information to the information processing apparatus 20 via the network 2 regardless of the delivery area in which the vehicle 10 is located.

The information processing apparatus 20 manages the delivery of packages. The information processing apparatus 20 is, for example, a computer such as a server apparatus. The information processing apparatus 20 can communicate with the vehicle 10 and the mobile terminal 30 via the network 2. The information processing apparatus 20 receives the positional information for the vehicle 10 via the network 2. The information processing apparatus 20 transmits a delivery plan to the mobile terminal 30 (30A, 30B, . . . , 30N) of each delivery person in charge of delivery operations in the delivery areas (delivery area 1, delivery area 2, . . . , delivery area n) and receives a delivery completion notification from the mobile terminal 30 of each delivery person.

The mobile terminal 30 is a mobile information terminal carried by a delivery person who delivers packages. The mobile terminal 30 receives a notification (such as the above-described delivery plan), an electronic key to lock/unlock the vehicle 10, or the like from the information processing apparatus 20 and transmits a response (such as the above-described delivery completion notification), an unlock/lock request for the vehicle 10, or the like to the information processing apparatus 20. The mobile terminal 30 is, for example, a mobile phone, a smartphone, a tablet, a personal computer (PC), or the like. The mobile terminal 30 can communicate with the vehicle 10 and the information processing apparatus 20 via the network 2.

First, an outline of the present embodiment will be described, and details thereof will be described later. The information processing apparatus 20 forming part of the information processing system 1 formulates a delivery plan, in which the vehicle 10 is assigned to a delivery destination in a first delivery area, based on information on the first delivery area including a predetermined location to which a package is to be delivered and information on a vehicle designated by a consignee as a delivery destination of the package, and excludes the vehicle 10 from the delivery destination in the delivery plan in a case in which the vehicle 10 moves from the predetermined location before completion of delivery to the vehicle 10, or in a case in which the vehicle 10 is not located at the predetermined location at a target time before completion of delivery to the vehicle 10. The information processing apparatus 20 is, for example, a dedicated computer configured to function as a server, a general purpose personal computer, a cloud computing system, or the like. The predetermined location is, for example, a location designated by the consignee or delivery service provider as the delivery destination of the package. The consignee parks the vehicle at the predetermined location to receive the package. The delivery person delivers the package to the vehicle parked at the predetermined location according to the delivery plan. While details are provided below, the target time is the time that is used as a reference for determining whether the vehicle 10 is located at the predetermined location before delivery of the package.

In this way, according to the present embodiment, the information processing apparatus 20 can exclude the vehicle 10 from the delivery destination in the delivery plan in a case in which the vehicle 10 is not located at the predetermined location before completion of delivery of the package to the vehicle 10. Compared to a case in which a vehicle 10 that is not located at the predetermined location is not excluded from the delivery destination, this reduces the probability of inconveniences such as a package being undeliverable when the delivery person cannot find the vehicle 10, or the delivery plan needing to be modified for delivery to the vehicle 10 that has moved. Technology for package delivery in which the trunk of a vehicle can be designated as the delivery destination is therefore improved.

Next, configurations of the information processing system 1 will be described in detail.

(Configuration of Vehicle)

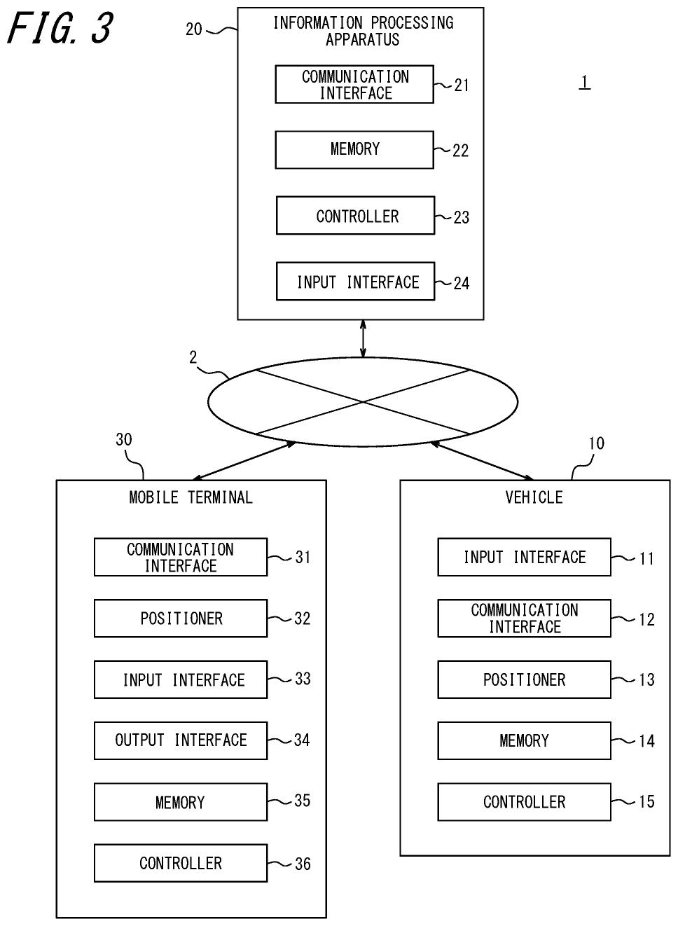

As illustrated in FIG. 3, the vehicle 10 includes an input interface 11, a communication interface 12, a positioner 13, a memory 14, and a controller 15.

The input interface 11 is capable of accepting an input from a consignee. The input interface 11 is configured to include at least one interface for input that is capable of accepting an input from the consignee. The interface for input is, for example, a physical key, a capacitive key, a pointing device, a touch screen integrally provided with the display, a barcode reader, an IC card reader, a microphone, or the like. However, the interface for input is not limited to this.

The communication interface 12 includes at least one interface for communication for connecting to the network 2. The communication interface is compliant with mobile communication standards such as the 4th generation (4G) standard or the 5th generation (5G) standard, for example, but these examples are not limiting. In the present embodiment, the vehicle 10 communicates with the information processing apparatus 20 via the communication interface 12 and the network 2.

The positioner 13 includes one or more apparatuses configured to acquire positional information for the vehicle 10. Specifically, the positioner 13 includes, for example, a receiver compliant with GPS, but is not limited to this example and may include a receiver compliant with any appropriate satellite positioning system.

The memory 14 includes one or more memories. The memories are semiconductor memories, magnetic memories, optical memories, or the like, for example, but are not limited to these. The memories included in the memory 14 may each function as, for example, a main memory, an auxiliary memory, or a cache memory. The memory 14 stores any information used for operations of the vehicle 10. For example, the memory 14 may store a system program, an application program, embedded software, and the like. The information stored in the memory 14 may be updated with, for example, information acquired from the network 2 via the communication interface 12.

The controller 15 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 15 controls the operations of the entire vehicle 10.

The controller 15 acquires positional information for the vehicle 10 and transmits the acquired positional information for the vehicle 10, together with identification information for the vehicle, to the information processing apparatus 20 at predetermined time intervals. The positional information for the vehicle 10 may be transmitted at predetermined time intervals, the positional information may be accumulated in the memory 14 of the vehicle 10 and transmitted collectively at predetermined times (for example, while the vehicle 10 is parked), or the positional information may be transmitted in response to a request from the information processing apparatus 20.

(Configuration of Information Processing Apparatus)

As illustrated in FIG. 3, the information processing apparatus 20 includes a communication interface 21, a memory 22, a controller 23, and an input interface 24.

The communication interface 21 includes at least one interface for communication for connecting to the network 2. The communication interface may be compliant with, for example, mobile communication standards, wired local area network (LAN) standards, or wireless LAN standards, but these examples are not limiting. The communication interface may be compliant with any appropriate communication standards. In the present embodiment, the information processing apparatus 20 receives positional information for the vehicle 10 via the communication interface 21 and the network 2. The information processing apparatus 20 communicates with the mobile terminal 30 carried by the delivery person via the communication interface 21 and the network 2.

The memory 22 includes one or more memories. The memories included in the memory 22 may each function as, for example, a main memory, an auxiliary memory, or a cache memory. The memory 22 stores any information used for operations of the information processing apparatus 20. For example, the memory 22 may store a system program, an application program, a database, the delivery plan, the positional information for the vehicle 10 (map information), and the like. The information stored in the memory 22 may be updated with, for example, information acquired from the network 2 via the communication interface 21.

The controller 23 includes at least one processor, at least one programmable circuit, at least one dedicated circuit, or a combination of these. The controller 23 controls the operations of the entire information processing apparatus 20.

(Configuration of Mobile Terminal)

As illustrated in FIG. 2, the mobile terminal 30 includes a communication interface 31, a positioner 32, an input interface 33, an output interface 34, a memory 35, and a controller 36.

The communication interface 31 is configured to include at least one communication module for connection to the network 2. The communication module is, for example, a communication module compliant with a mobile communication standard such as LTE, 4G, or 5G. However, the communication module is not limited to this. The communication module may be compliant with any communication standard.

The positioner 32 can acquire positional information for the mobile terminal 30. The positioner 32 is configured to include at least one receiving module corresponding to a satellite positioning system. The receiving module is, for example, a receiving module corresponding to the GPS. The receiving module is not, however, limited to this example. The receiving module may be a receiving module corresponding to any appropriate satellite positioning system.

The input interface 33 is capable of accepting an input from the delivery person. The input interface 33 is configured to include at least one interface for input that is capable of accepting an input from the delivery person. The interface for input is, for example, a physical key, a capacitive key, a pointing device, a touch screen integrally provided with a display, a microphone, or the like. However, the interface for input is not limited to this.

The output interface 34 is capable of outputting data. The output interface 34 is configured to include at least one interface for output that is capable of outputting data. The interface for output is, for example, a display, a speaker, or the like. The display is, for example, an LCD, an organic EL display, or the like. However, the interface for output is not limited to this.

The memory 35 is configured to include at least one semiconductor memory, at least one magnetic memory, at least one optical memory, or a combination of at least two of these. The semiconductor memory is, for example, RAM, ROM, or the like. The RAM is, for example, SRAM, DRAM, or the like. The ROM is, for example, EEPROM or the like. The memory 35 may function as a main memory, an auxiliary memory, or a cache memory. The memory 35 stores data to be used for the operations of the mobile terminal 30 and data obtained by the operations of the mobile terminal 30.

The controller 36 executes processes related to operations of the mobile terminal 30 while controlling components of the mobile terminal 30.

The functions of the mobile terminal 30 are realized by execution of a terminal program according to the present embodiment by a processor corresponding to the controller 36. That is, the functions of the mobile terminal 30 are realized by software. The terminal program causes a computer to execute the operations of the mobile terminal 30, thereby causing the computer to function as the mobile terminal 30. That is, the computer executes the operations of the mobile terminal 30 in accordance with the terminal program to thereby function as the mobile terminal 30.

Some or all of the functions of the mobile terminal 30 may be realized by a dedicated circuit corresponding to the controller 36. That is, some or all of the functions of the mobile terminal 30 may be realized by hardware.

The controller 36 controls the positioner 32 to acquire positional information for the mobile terminal 30. The controller 36 controls the communication interface 31 to transmit, to the information processing apparatus 20 via the network 2, the acquired positional information for the mobile terminal 30, together with identification information for the delivery person carrying the mobile terminal 30. The identification information for the delivery person is information capable of uniquely identifying the delivery person. The controller 36 may acquire, at established time intervals, the positional information for the mobile terminal 30 and transmit the acquired positional information for the mobile terminal 30, together with the identification information for the delivery person, to the information processing apparatus 20. The time intervals may be set based on, for example, the average speed at which the mobile terminal 30 moves.

(Flow of Operations of Information Processing Apparatus 20)

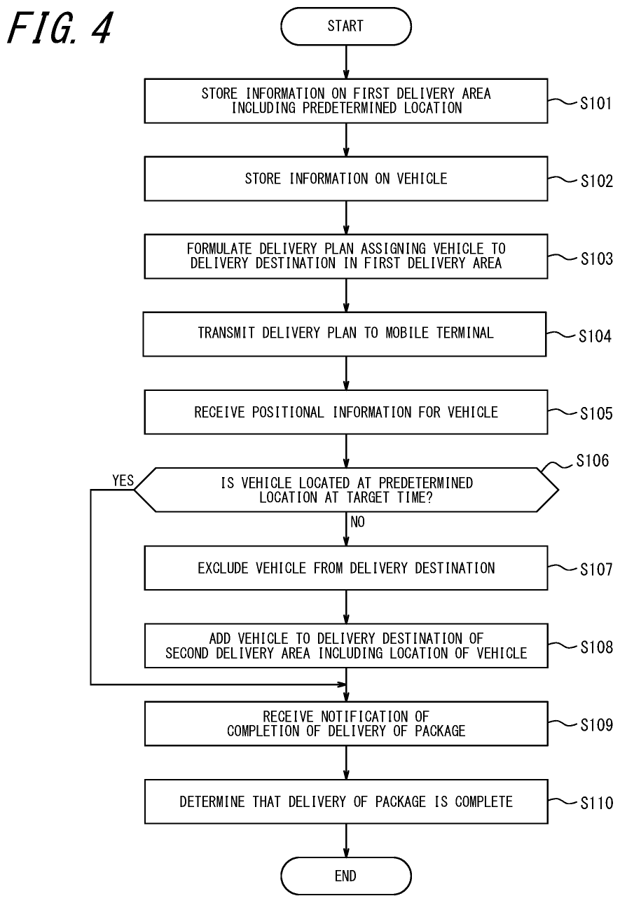

Operations of the information processing apparatus 20 according to the present embodiment will be described with reference to FIG. 4.

Step S101: the memory 22 of the information processing apparatus 20 stores information on the first delivery area that includes the predetermined location to which the package is to be delivered.

The predetermined location is a location designated by the consignee or delivery service provider as the delivery destination of the package. Predetermined locations include, for example, the area of which the delivery person in each delivery area is in charge, a designated parking lot of the consignee or delivery service provider or a surrounding area thereof, or the location of the vehicle when the delivery plan for each delivery area is determined. The consignee parks the vehicle at the predetermined location to receive the package. The delivery person delivers the package to the vehicle parked at the predetermined location according to the delivery plan. In the present embodiment, the delivery area that includes the predetermined location where the package is to be delivered is assumed to be the first delivery area among one or more delivery areas classified by the delivery service provider.

Step S102: the memory 22 of the information processing apparatus 20 stores information on the vehicle designated by the consignee as the delivery destination of the package.

The information on the vehicle is information that identifies the vehicle designated by the information processing apparatus 20 or the delivery person as the delivery destination for the package. The information on the vehicle includes, for example, (i) text information or image information on the vehicle type, body color, and the like, (ii) vehicle identification information such as the license plate number, (iii) positional information for the vehicle 10, as measured by a satellite positioning system such as GPS, received by the information processing apparatus 20 from the vehicle 10, and (iv) the delivery time slot desired by the consignee, or the parking location of the vehicle as designated by the consignee.

Step S103: the controller 23 of the information processing apparatus formulates a delivery plan, in which the vehicle 10 is assigned to a delivery destination in the first delivery area, based on the information on the first delivery area including the predetermined location and the information on the vehicle.

The delivery region in which the delivery service provider make deliveries is divided into one or more delivery areas (first delivery area, second delivery area, . . . , nt h delivery area), as illustrated in FIG. 2. For one or more vehicles designated as the delivery destination, the controller 23 reads the information on the delivery area, including the predetermined location, and the information on the vehicle from the memory 22. From the information on each vehicle, the controller 23 assigns each vehicle to a delivery area (in the present example, the vehicle 10 is assigned to the first delivery area) and further adjusts the scheduled time of delivery to each vehicle in chronological order based on the desired time of delivery and the like included in the information on the vehicle to formulate a delivery plan for each delivery area.

Step S104: the communication interface 21 of the information processing apparatus 20 transmits the delivery plan to the mobile terminal 30 carried by the delivery person.

Each delivery area of a delivery service provider is assigned at least one delivery person (delivery person in charge) who is in charge of delivering packages. The information processing apparatus 20 transmits the delivery plan for each delivery area to the delivery person in charge of each area. Each delivery area may be assigned more than one delivery person, depending on the circumstances of each delivery area.

Step S105: the communication interface 21 of the information processing apparatus 20 receives the positional information for the vehicle 10 from the vehicle 10.

As described above, the positioner 13 of the vehicle 10 includes a receiver corresponding to any satellite positioning system, such as GPS, for acquiring the positional information for the vehicle 10. The controller 15 of the vehicle 10 may transmit the positional information for the vehicle 10 to the information processing apparatus 20 via the communication interface 12 at predetermined time intervals, or the positional information may be accumulated in the memory 14 of the vehicle 10 and transmitted collectively at predetermined times (for example, while the vehicle 10 is parked). The controller 15 of the vehicle 10 may also transmit the positional information for the vehicle 10 via the communication interface 12 in response to a request from the information processing apparatus 20.

Step S106: the controller 23 of the information processing apparatus 20 determines whether the vehicle 10 has moved from the predetermined location before completion of delivery to the vehicle 10, or whether the vehicle 10 was located at the predetermined location at the target time before completion of delivery to the vehicle 10. The controller 23 (i) proceeds to step S107 in a case in which the vehicle 10 has moved from the predetermined location prior to completion of delivery to the vehicle 10, or in a case in which the vehicle 10 is not located at the predetermined location at the target time prior to completion of delivery to the vehicle 10, and (ii) proceeds to step S109 in a case in which the vehicle 10 has not moved from the predetermined location prior to completion of delivery to the vehicle 10, or in a case in which the vehicle 10 is located at the predetermined location at the target time prior to completion of delivery to the vehicle 10.

The target time is the time that is used as a reference for determining whether the vehicle 10 is located at the predetermined location before delivery of the package. The target time may, for example, be (i) the time when a predetermined amount of time elapses after the vehicle 10 moves from the predetermined location, (ii) the time that is a predetermined amount of time before the scheduled delivery time to the vehicle 10, or (iii) a completed delivery time or scheduled delivery time to a delivery destination that is a predetermined number of deliveries before delivery to the vehicle 10.

Step S107: the controller 23 of the information processing apparatus 20 excludes the vehicle 10 from the delivery destination in the delivery plan.

For example, in a case in which the vehicle 10 was registered in the delivery plan for the first delivery area, the controller 23 removes the vehicle 10 from the delivery plan for the first delivery area and transmits the updated delivery plan for the first delivery area to the mobile terminal 30 carried by the person in charge of delivery in the first delivery area. Upon the delivery plan being updated, the person in charge of delivery can determine that the package does not need to be delivered to the vehicle 10, thereby reducing the probability of inconveniences such as the package being undeliverable because the vehicle 10 cannot be found, or the delivery plan being modified.

Step S108: the controller 23 of the information processing apparatus 20 adds the vehicle 10 to a delivery destination in the second delivery area that includes the location of the vehicle 10 indicated by the positional information when the vehicle 10 is excluded from the delivery destination.

Upon the vehicle 10 being added to the delivery destination in the delivery area of the travel destination (for example, the second delivery area), the package is delivered to the vehicle 10 by the delivery person in charge of the second delivery area. In such a case, the package needs to be transported from the person in charge of delivery in the first delivery area to the person in charge of delivery in the second delivery area. Since the vehicle 10 is added to the delivery plan for the second delivery area, the probability of inconveniences such as the need to modify the delivery plans in delivery areas other than the first delivery area, such as the second delivery area, is reduced.

Step S109: the communication interface 21 of the information processing apparatus 20 receives a notification of completion of delivery of the package to the trunk of the vehicle 10 from the mobile terminal 30.

The person in charge of delivery unlocks the vehicle 10 located at the predetermined location and delivers the package to the trunk. Upon completion of the delivery, the person in charge of delivery locks the vehicle 10 and transmits a delivery completion notification to the information processing apparatus 20 from the mobile terminal 30 the person in charge of delivery is carrying.

Step S110: the controller 23 of the information processing apparatus 20 determines that the package has been delivered to the trunk of the vehicle 10.

Upon receiving the notification of completion of delivery to the vehicle 10 from the mobile terminal 30, the controller 23 of the information processing apparatus 20 determines that the package has been delivered to the trunk of the vehicle 10.

As described above, the information processing apparatus 20 according to the present embodiment determines whether the vehicle 10 has moved from the predetermined location before completion of delivery to the vehicle 10, or whether the vehicle 10 was located at the predetermined location at the target time before completion of delivery to the vehicle 10. The information processing apparatus 20 then excludes the vehicle 10 from the delivery destination in the delivery plan in a case in which the vehicle 10 moved from the predetermined location before completion of delivery of the package to the vehicle 10 or the vehicle 10 is not located at the predetermined location.

According to this configuration, the information processing apparatus 20 can exclude the vehicle 10 from the delivery destination in the delivery plan in a case in which the vehicle 10 moved from the predetermined location before completion of delivery of the package to the vehicle 10 or the vehicle 10 is not located at the predetermined location. Compared to a case in which a vehicle 10 that is not located at the predetermined location is not excluded from the delivery destination, this reduces the probability of inconveniences such as a package being undeliverable when the delivery person cannot find the vehicle 10, or the delivery plan needing to be modified for delivery to the vehicle 10 that has moved. Technology for package delivery in which the trunk of a vehicle can be designated as the delivery destination is therefore improved.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which the configuration and operations of the information processing apparatus 20 in the above embodiment are distributed to multiple computers capable of communicating with each other can be implemented. For example, an embodiment in which some or all of the components of the information processing apparatus 20 are provided in the vehicle 10 can also be implemented.

For example, an embodiment in which a general purpose computer functions as the information processing apparatus 20 according to the above embodiment can also be implemented. Specifically, a program in which processes for realizing the functions of the information processing apparatus 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

As described above, the configuration and operations of the information processing apparatus 20 may be distributed to multiple computers capable of communicating with each other. For example, the functions of the information processing apparatus 20 may be distributed between a vehicle positional information management apparatus 20B, which receives positional information from the vehicle 10 and manages the positional information, and an information processing apparatus 20A, which receives positional information for the vehicle 10 via the vehicle positional information management apparatus 20B, rather than directly from the vehicle 10, and executes predetermined processing. The vehicle positional information management apparatus 20B that manages the positional information for the vehicle may be a server of the automobile manufacturer that produced the vehicle 10. In such a case, an information processing apparatus A of the delivery service provider receives the positional information for the vehicle 10 from the server of the automobile manufacturer, which functions as the vehicle positional information management apparatus 20B.

As also described above, in a case in which the vehicle 10 is excluded from the delivery destination in the first delivery area, or the vehicle 10 is added to the delivery destination of the second delivery area, the information processing apparatus 20 may notify the consignee in advance that the vehicle 10 is being excluded from the delivery destination in the first delivery area or that the vehicle 10 is being added to the delivery destination in the second delivery area. This configuration enables the consignee to be involved in re-setting the predetermined location and the target time in the second delivery area, thereby further reducing the probability of inconveniences such as the package being undeliverable in the second delivery area, or the delivery plan being modified.

1. An information processing apparatus for managing delivery of packages, the information processing apparatus comprising:
a memory configured to store information on a first delivery area including a predetermined location to which a package is to be delivered and information on a vehicle designated by a consignee as a delivery destination of the package;
a communication interface configured to receive positional information for the vehicle; and
a controller configured to formulate a delivery plan, in which the vehicle is assigned to a delivery destination in the first delivery area, based on the information on the first delivery area including the predetermined location and the information on the vehicle and to exclude the vehicle from the delivery destination in the delivery plan in a case in which the vehicle moves from the predetermined location before completion of delivery to the vehicle, or in a case in which the vehicle is not located at the predetermined location at a target time before completion of delivery to the vehicle.

2. The information processing apparatus according to claim 1, wherein the controller is configured to add the vehicle to a delivery destination in a second delivery area that includes a location of the vehicle indicated by the positional information when the vehicle is excluded from the delivery destination.

3. The information processing apparatus according to claim 1, wherein the target time is a time when a predetermined amount of time elapses after the vehicle moves from the predetermined location, a time that is a predetermined amount of time before a scheduled delivery time to the vehicle, or a completed delivery time or scheduled delivery time to a delivery destination that is a predetermined number of deliveries before delivery to the vehicle.

4. An information processing method to be executed by an information processing apparatus for managing delivery of packages, the information processing method comprising:
storing information on a first delivery area including a predetermined location to which a package is to be delivered and information on a vehicle designated by a consignee as a delivery destination of the package;
receiving positional information for the vehicle;
formulating a delivery plan, in which the vehicle is assigned to a delivery destination in the first delivery area, based on the information on the first delivery area including the predetermined location and the information on the vehicle; and
excluding the vehicle from the delivery destination in the delivery plan in a case in which the vehicle moves from the predetermined location before completion of delivery to the vehicle, or in a case in which the vehicle is not located at the predetermined location at a target time before completion of delivery to the vehicle.

5. A non-transitory computer readable medium storing a program configured to cause an information processing apparatus for managing delivery of packages to execute operations, the operations comprising:
storing information on a first delivery area including a predetermined location to which a package is to be delivered and information on a vehicle designated by a consignee as a delivery destination of the package;
receiving positional information for the vehicle;
formulating a delivery plan, in which the vehicle is assigned to a delivery destination in the first delivery area, based on the information on the first delivery area including the predetermined location and the information on the vehicle; and
excluding the vehicle from the delivery destination in the delivery plan in a case in which the vehicle moves from the predetermined location before completion of delivery to the vehicle, or in a case in which the vehicle is not located at the predetermined location at a target time before completion of delivery to the vehicle.
